(19) United States
(12) Patent Application Publication
(10) Pub. No.: US 2017/0031652 A1
(43) Pub. Date: Feb. 2, 2017

(54) VOICE-BASED SCREEN NAVIGATION APPARATUS AND METHOD

(71) Applicant: Samsung Electronics Co., Ltd., Suwon-si (KR)

(72) Inventors: Hye Jin KAM, Seongnam-si (KR); Kyoung Gu WOO, Seoul (KR); Jung Hoe KIM, Seongnam-si (KR)

(73) Assignee: Samsung Electronics Co., Ltd., Suwon-si (KR)

(21) Appl. No.: 15/210,293

(22) Filed: Jul. 14, 2016

(30) Foreign Application Priority Data
Jul. 29, 2015 (KR) 10-2015-0107523

(51) Int. Cl. G06F 3/16; G10L 17/22; G06F 3/01

(52) U.S. Cl. CPC G06F 3/167; G06F 3/013; G06F 3/017; G10L 17/22; G10L 2015/223

(57) ABSTRACT

A screen navigation apparatus includes a command receiver configured to receive an input voice command regarding navigation of a screen, and a processor configured to interpret the voice command based on an analysis result of content displayed on a screen and compose a command executable by the screen navigation apparatus and perform navigation of the screen.

### CROSS-REFERENCE TO RELATED APPLICATION(S)

This application claims the benefit under 35 USC 119(a) of Korean Patent Application No. 10-2015-0107523, filed on Jul. 29, 2015, in the Korean Intellectual Property Office, the entire disclosure of which is incorporated herein by reference for all purposes.

### BACKGROUND

1. Field

The following description relates to a voice-based screen navigation apparatus and method.

2. Description of Related Art

There have been suggested apparatuses of various forms and methods for checking information that is displayed on devices, such as TVs, computers, tablet devices, and smartphones, as well as separately for inputting commands to process the checked information. Generally, information is input via a device, such as a remote controller, a mouse, and a keyboard, or via touch input. More recent input attempts have involved the interpreting of user voice input to control a device. However, these latest attempts only enable execution of implementing designated functions or simple applications based on preset, fixed commands.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a screen navigation apparatus includes a command receiver configured to receive an input voice command regarding navigation of a screen, and a processor configured to interpret the voice command based on an analysis result of content displayed on a screen and compose a command executable by the screen navigation apparatus and perform navigation of the screen.

The screen navigation apparatus may further include a memory configured to store instructions. The processor may be further configured to execute the instructions to configure the processor to interpret the voice command based on the analysis result of the content displayed on the screen and compose the command executable by the screen navigation apparatus, and perform the navigation of the screen.

The processor may include a command composer configured to interpret the voice command based on the analysis result of the content displayed on the screen and compose the command executable by the screen navigation apparatus, and a command executer configured to perform the navigation of the screen.

The processor may further include a screen analyzer configured to analyze the content displayed on the screen and generate the content analysis result. The screen analyzer may be configured to analyze the content using one or more of the following techniques: source analysis, text analysis, speech recognition, image analysis and context information analysis. The content analysis result may include a semantic map or a screen index, or both, wherein the semantic map represents a determined meaning of the content displayed on the screen, and the screen index indicates a determined position of the content displayed on the screen. The screen index may include at least one of the following items: coordinates, grids, and identification symbols, and the screen analyzer determines at least one of a type, size, and position of the screen index to be displayed on the screen by taking into account at least one of the following factors: coordinates of the screen index, a screen resolution, and positions and distribution of key contents on the screen, and displays the screen index on the screen based on the determination. In response to a user selecting one of screen indices displayed on the screen by a user's speech, eye-gaze, or gesture, or any combination thereof, the command composer may be configured to interpret the voice command based on screen position information that corresponds to the selected screen index.

The command receiver may be configured to receive the input voice command from a user in a predetermined form or in a form of natural language. The processor may further include the command receiver. The command composer may include a command converter configured to refer to a command set database (DB) and convert the input voice command into a command executable by the screen navigation apparatus. The command set DB may include a common command set DB or a user command set DB, or both, wherein the common command set DB stores common command sets and the user command set DB that stores command sets personalized for a user.

The command composer may include an additional information determiner configured to determine whether the input voice command is sufficient to be composed into the command, and a dialog agent configured to present a query to request the user to provide additional information in response to the determination indicating that the voice command is not sufficient. The dialog agent may be configured to create the query as multistage subqueries, and present a subquery based on a user's reply to a subquery presented in a previous stage.

The command composer may be configured to interpret the incoming voice command in stages and compose a command for each stage while the user's voice command is being input, and the command executer may be configured to navigate the screen in stages by executing the commands.

The navigation of the screen may include one or more of the following operations: keyword highlighting, zoom-in, opening a link, running an image, playing video, and playing audio.

The screen navigation apparatus may be a smartphone, a laptop, a tablet, a smart watch, or a computer, and may further include a screen and a user interface.

In another general aspect, a screen navigation method includes receiving a voice command regarding navigation of a screen, interpreting the voice command based on an analysis result of content displayed on the screen and composing a command, and performing navigation of the screen based on execution of the command.

The screen navigation method may further include analyzing content displayed on the screen and generating a content analysis result. The content analysis result may include a semantic map or a screen index, or both. The semantic map may represent a determined meaning of the content displayed on the screen and the screen index may indicate a determined position of the content displayed on the screen. The composing of the command may include, in response to the screen index displayed on the screen being selected by a user's speech, eye-gaze or gesture, or any combination thereof, interpreting the received voice command based on screen position information that corresponds to the selected screen index.

The receiving of the voice command may include receiving the input voice command from a user in a predetermined form or in a form of natural language. The composing of the command may include comparing the input voice command to a command set database (DB) and converting the input voice command into the command.

The composing of the command may include determining whether the input voice command is sufficient to be composed into a command, and in response to a result of the determining being that the voice command is not sufficient, presenting a query to request the user to provide additional information. The presenting of the query may include creating the query as multistage subqueries, and presenting a subquery based on a user's reply to a subquery presented in a previous stage.

The composing of the command may include interpreting the incoming voice command in stages while a user's voice command is being input and composing a command for each stage, and the performing of the navigation may include navigating the screen in stages by executing the commands.

Other features and aspects will be apparent from the following detailed description, the drawings, and the claims.

### BRIEF DESCRIPTION OF THE DRAWINGS

FIG. 1 is a diagram illustrating a screen navigation apparatus according to an embodiment.

FIG. 2 is a diagram illustrating an example of a screen analyzer according to an embodiment.

FIGS. 3A to 3C are diagrams illustrating examples of the command composer according to embodiments.

FIGS. 4A to 4D are diagrams for explaining screen indices displayed on a screen by an index display according to embodiments.

FIGS. 5A to 5D are diagrams for explaining procedures of creating a semantic map by a semantic map generator according to an embodiment.

FIGS. 6A to 6D are diagrams illustrating an example of navigation of the screen performed by a command executer according to an embodiment.

FIG. 7 is a flowchart illustrating a screen navigation method according to an embodiment.

FIG. 8 is a flowchart illustrating a screen navigation method according to an embodiment.

Throughout the drawings and the detailed description, the same reference numerals may refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

A screen navigation apparatus may be an electronic device that is equipped with a display device or that is connected to a physically separate, external display device in either a wired or wireless manner. Alternatively, the screen navigation apparatus may also be mounted in or as a hardware module in an electronic device that has a display function. Here, the electronic device may be a smart TV, a smart watch, a smartphone, a tablet PC, a desktop PC, a laptop PC, a head-up display, a holographic device, or a variety of wearable devices. Aspects of the present disclosure are not limited thereto, and as such, an electronic device may be construed as any type of device capable of data processing.

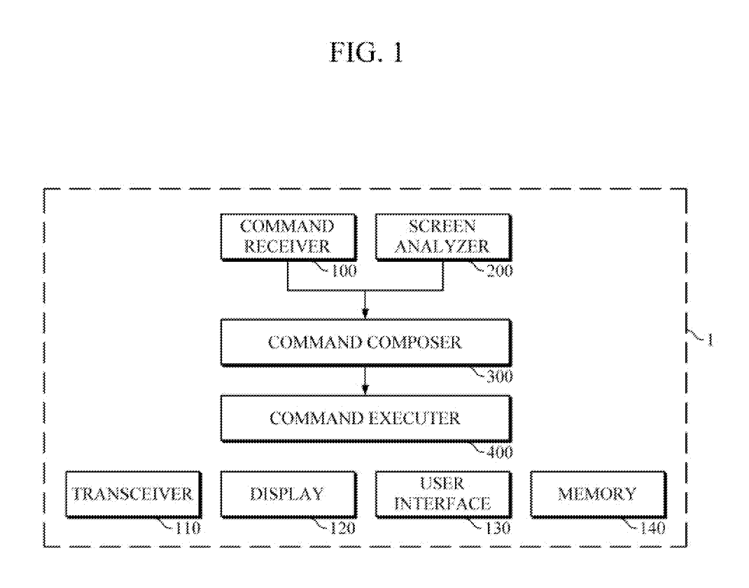

FIG. 1 is a diagram illustrating a screen navigation apparatus according to an embodiment.

Referring to FIG. 1, a screen navigation apparatus 1 may include a command receiver 100, a screen analyzer 200, a command composer 300, a command executer 400, a transceiver 110, display 120, a user interface 130, and memory 140.

The command receiver 100 receives an input of a voice command (hereinafter, referred to as a “primary command”) regarding navigation of the screen. A user may input a primary command in a predesignated format or in the form of natural language. A command in the predesignated format may be a simple command about general functions that the screen navigation apparatus 1 can process.

The command receiver 100 may receive an analog voice signal input through a microphone of an electronic device, or a microphone of the user interface 130, and convert the received voice signal into a digital signal.

The screen analyzer 200 may analyze content displayed on a screen of a display device, or the display 120, and generate a content analysis result. The content may include any entity displayed on the screen, such as various applications, messages, emails, documents, songs, videos, images, and other entities (e.g., text input windows, click buttons, dropdown menus, etc.). The content analysis result may include, as described below, either or both of a sematic map and a screen index, where the semantic map represents the meaning of content and the screen index guides the user to designate a location on the screen. However, the content analysis result is not limited thereto.

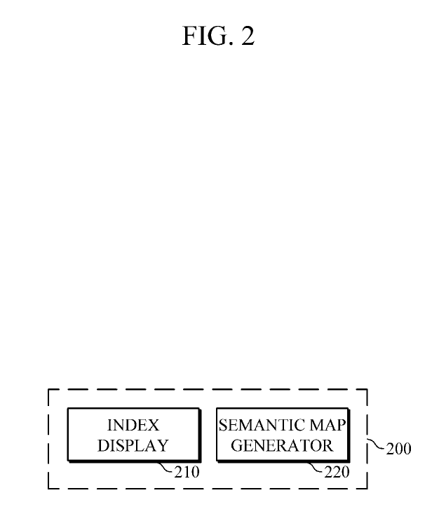

FIG. 2 is a diagram illustrating an example of a screen analyzer according to an embodiment. The screen analyzer embodiment of FIG. 2 may represent the screen analyzer of FIG. 1, though embodiments are not limited thereto.

Referring to FIG. 2, in this example, the screen analyzer 200 includes an index display 210 and/or a semantic map generator 220.

The index display 210 generates a screen index that guides the user to designate a location on the displayed screen and controls a display of, or displays, the generated screen index on the screen. The screen index that is created may be a set of coordinates, a grid, or an identification symbol that is of a certain form, e.g., a point, a circle, a rectangle, or an arrow.

According to an embodiment, the index display 210 may display the screen index based on a predesignated type, size, and display location. For example, depending on what is desired, the screen index may be set in advance, either automatically, by default, or by the user, as an 8-grid, a 16-grid, an 8 by 8 grid, etc.

In an embodiment, the index display 210 may determine a type, a size, and a display location of an index to be displayed on the screen by taking into account one or more of the following factors: the size and resolution of the screen, and types, locations, and distribution of the main content that is to be output to the screen. The index display 210 may combine two or more screen indices and display the result on the screen.

For example, if pieces, portions, or elements of the main content are concentrated on a particular area of the screen while other areas are empty or pieces, portions, or elements of less important content are displayed in the areas, the index display 210 may display the screen index to be more focused on said particular area where the pieces of main content are densely arranged. Hence, if the screen index were to be presented in the form of a grid, parts of the grid in an area where pieces of the main content are concentrated may be displayed to be relatively smaller as compared to other parts of the grid in the remaining area, where the grid parts and corresponding pieces may be respectively larger.

The index display 210 may display a screen index when content is displayed on the screen for the first time or for each time content is changed on the screen. Also, the index display 210 may display a screen index in response to a user's voice command.

The semantic map generator 220 may analyze all pieces of content displayed on the screen and create a semantic map that presents the meanings of pieces of the main content. By using various schemes to analyze the pieces of content displayed on the screen, the semantic map generator 220 may define the meanings of said pieces.

For example, if a web page is displayed on the screen, the semantic map generator 220 analyzes sources of the web page using a source analysis scheme so as to identify the meanings of pieces of content on the web page, i.e., whether each piece of content is an input window, an image, an icon, a link table, or a video, as only an example. However, the content may be defined differently and hence aspects of the present disclosure are not limited to the above examples.

In another example, the semantic map generator 220 may identify the meanings of objects in each content using an analysis scheme associated with each content, such as, image recognition, text recognition, object recognition, speech recognition, classification, and naming schemes.

In another example, the semantic map generator 220 may obtain the meanings of pieces of content based on recognition of context information. In other words, an input window may be defined as either a search window or a sign-in window depending on context information.

Also, the semantic map generator 220 may analyze pieces of content using one or more of the aforesaid schemes, and may create a semantic map by defining the meaning of each piece of content based on consolidation of all results from the analyses. Referring back to FIG. 1, for example, the command receiver 100 may receive a user's command (hereinafter, referred to as an “additional command”) to designate a location on the screen or to select specific content on the screen. The command receiver 100 may receive the additional command together with the primary command, or may receive the additional command separately after a certain time interval, e.g., after a predetermined 3 seconds have elapsed.

In one embodiment, the user may input an additional voice command to select a screen index displayed on the screen. For example, if the user wants to enlarge a specific part (e.g., “segment 1”) of a grid which is displayed as a screen index on a screen, the user may input a primary command, “Enlarge”, and then input an additional command, “Segment 1”, after a certain length of time has passed, or the user may input both commands together, “Enlarge Segment 1.”

In an embodiment, in the case where a semantic map for the content has previously been created on the screen and each piece of content has been previously defined with a description, the user may vocally input an additional command by saying the desired description of the piece of content. For example, when the description of video content displayed on a particular area of the screen is defined as “car advertisement” in the semantic map, if the user wants to play said video content, the user may input an additional command by saying “car advertisement.” Similar to the above example, the user may input a primary command “Play” and then input an additional command “car advertisement” after a certain time interval, or the user may input both commands together, i.e., “Play car advertisement”.

According to one or more embodiments, the user may input an additional command via an auxiliary input device, such as by gazing at the screen index or specific content, which is displayed at a desired location on the screen. The command receiver 100 may obtain information regarding a user's eye-gazing direction, and may identify the screen index or content that the user has chosen based on said information. For example, the user's eye-gazing direction may be determined using an image sensor, or camera, represented by the user interface 130 of FIG. 1. The eye-gazing direction may be determined by identifying a direction of a user's pupil in relation to a user interface or screen. As an example, the auxiliary input device may include a wearable device in the form of glasses or contact lenses, but it is not limited thereto.

In the based example, if the user stares at a particular area of the screen or makes a gesture, the command receiver 100 may control a camera module mounted in the screen navigation apparatus 1 or an external camera module connected to said apparatus 1 so as to obtain an image of a user's face or gestures. The command receiver 100 may recognize the user's eye-gazing direction or the gestures of the user by utilizing various known facial recognition technologies or gesture recognition technologies.

The above embodiments are provided as examples to facilitate the understanding of the present disclosure, and aspects of the present disclosure are not limited thereto.

Returning to FIG. 1, the command composer 300 may create a command (hereinafter, referred to as a “navigation command”) in a format executable by the screen navigation apparatus 1 by using a user's voice command (primary command and/or additional command). The command composer 300 may interpret the voice command based on the content analysis result from the screen analyzer 200 and then convert said voice command into a navigation command.

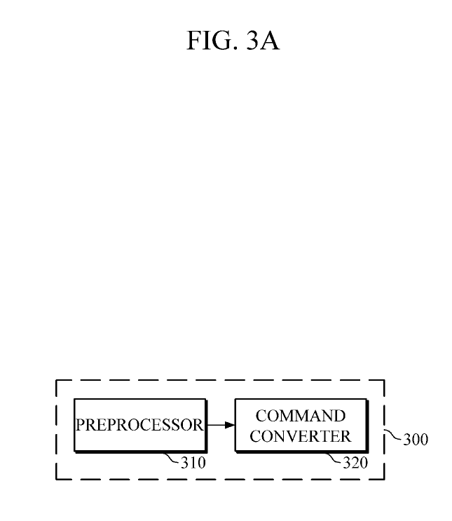

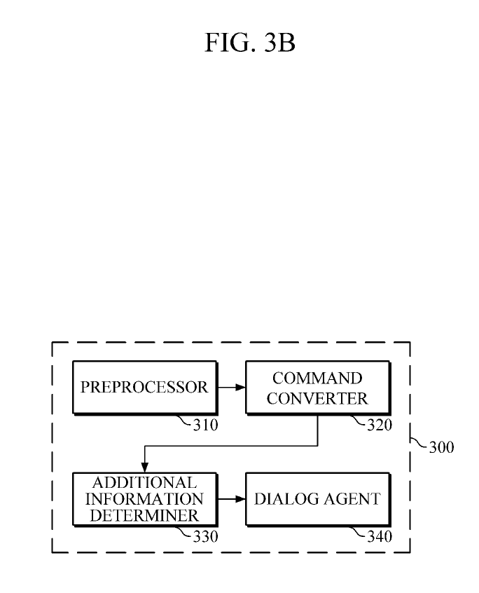

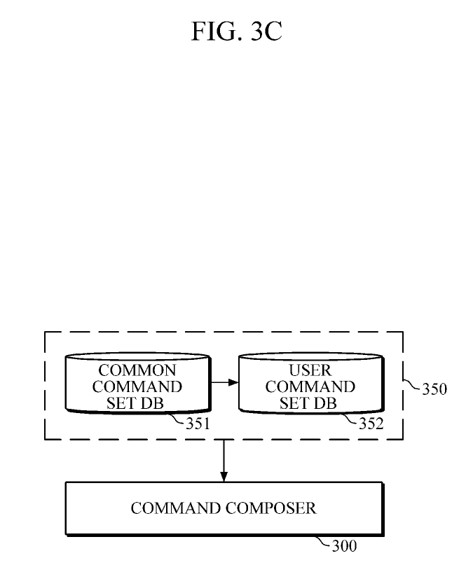

FIGS. 3A to 30 are diagrams illustrating examples of the command composer according to embodiments. The respective command composer 300 embodiments of FIGS. 3A through 30 may be representative of the command composer 300 illustrated in FIG. 1, though embodiments are not limited thereto.

Referring to FIG. 3A, the command composer 300 may include a preprocessor 310 and a command converter 320.

The preprocessor 310 may process a voice command into a format desired for converting said voice command into a navigation command. The processing performed by the preprocessor 310 may refer to a series of preparation and determination procedures that are carried out in order to generate a navigation command. Such procedures may include conversion of a voice command into a predefined format, recognition of a voice command and conversion of recognized speech into text, extraction of keywords from a voice command and understanding the meaning of extracted keywords, determinations regarding a voice command, detection of an object from a screen, understanding the content on a screen, and extraction of text from the screen. The recognition and/or conversion of the voice command may be implemented through various recognition models or algorithms, as only examples. The extraction and/or understanding of key words may be implemented through comparison of recognized words or phrases with vocabularies, or general or personalized databases, as only examples. Likewise, and again as only an example, any of the detecting of the objects, understanding of the content, and extraction of the text may be implemented by various recognition algorithms.

For example, when the user inputs the voice command “search for cars” while a web page is being displayed on the screen, the preprocessor 310 may extract keywords “search for” and “cars” from the voice command; understand the meaning of extracted keywords; determine that the user wanted to input the keyword “Cars” in a search window of the web page; and perform an operation corresponds to clicking the search button. At this time, the preprocessor 310 may check the search window content in the web page using an analysis result, e.g., a semantic map, which was obtained from the screen analyzer 200.

In another example, if the user inputs the voice command “let's see panda bear link” the preprocessor 310 may extract keywords, such as, “panda bear”, “link”, and “see” from the received voice command. In addition, the preprocessor 310 may detect an image of a panda bear from the screen, using object detection, text extraction, and/or meaning understanding technologies. Also, the preprocessor 310 may understand the meanings of the keywords “link” and “show”, in order to determine that the user wants to open a link of the panda bear image. At this time, if a semantic map has been created by the screen analyzer 200, the preprocessor 310 may use said map to thus easily identify the panda bear image from the content displayed on the screen.

Once the input voice command has been processed into a required format through preprocessing, the command converter 320 may generate a navigation command using a result thereof. At this time, the navigation command may be in a command format that is defined by a basic platform (e.g., web browser and an application) that drives the content on the screen.

For example, as described above, the preprocessor 310 may determine that the user's voice command is to execute the clicking of a “search window” into which a search keyword “cars” has been entered. The command converter 320 may configure an executable command that corresponds to user's gestures of entering “cars” in the search window by use of a keyboard and a mouse and of clicking a search button. For example, when included in the screen navigation apparatus 1, the command converter 320 may compose a command using scripts that describe commands executable by the screen navigation apparatus 1.

Referring to FIG. 3B, the command composer 300 may include a preprocessor 310, a command converter 320, an additional information determiner 330, and a dialog agent 340 according to an embodiment. Operations and implementations of the preprocessor 310 and the command converter 320 may be similar to the preprocessor 310 and command converter 320 of FIG. 3A, such descriptions will not be repeated for convenience of explanation.

The additional information determiner 330 may determine whether the primary command and/or the additional command input by the user meets a certain threshold to be considered sufficient enough to be composed into a navigation command. For example, when the command converter 320 composes a command that corresponds to a user's gesture of clicking a search button of a search window in response to a user's primary command “search,” the additional information determiner 330 may determine that additional information is desired regarding a search keyword to be entered into the search window. When the additional information determiner 330 determines that additional information is desired, the dialog agent 340 creates a query for additional information, and presents the query to the user. The dialog agent 340 may generate a natural language query to make the user feel that he/she is actually having a dialog. For example, like in the above case where the search keyword is insufficient, the dialog agent 340 may create a voice query, “what would you like to search for?” and presents the voice query to the user.

In one embodiment, the dialog agent 340 may create the query formed of multistage sub-queries, and sequentially present the second sub-query based on the user's reply to the first sub-query.

The additional information determiner 330 may determine whether an additional query is desired regarding the content analysis result from a screen analyzer 200, such as the screen analyzer 200 of either FIG. 1 or 2, i.e., whether content located at a specific area of the screen should be or needs to be further analyzed. If it is determined that the further analysis of the screen is desired, the additional information determiner 330 may request such a screen analyzer 200 for additional analysis.

Referring to FIG. 30, the command composer 300 may compose a navigation command from a voice command, using a command set database (DB) 350. The command set DB 350 may include a memory configured to be a part of the command composer 300 or separate.

The command set DB 350 may store command sets in the memory, where each command set is generated by mapping a common executable command (e.g., mouse click) that is carried out by the screen navigation apparatus 1 to a predefined keyword (e.g., search). As shown in FIG. 3C, the command set DB 350 may include a common command set DB 351 and/or a user command set DB 352.

Here, common command sets may refer to command sets in which executable commands that commonly carried out in an operating system of the screen navigation apparatus 1 or on a basic platform for providing screen content are mapped with major keywords related to a voice command that is commonly input by users.

Meanwhile, a user command set may be a set of particular commands, or a set of commands personalized for each user with respect to a sequence of consecutive commands, wherein the personalization may be performed based on keywords, phrases, and gestures, or any combination thereof. For example, different users may use different keywords, such as “search” or “click” as a particular command, instead of what would usually be the “click” command, for carrying out the operation of clicking a search button in a web page. In this case, each user may configure a user command set by mapping a frequently used keyword to an actual command “click”.

In another example, each user may define a shortcut key using a combination of several words, phrases, and sentences, and configure a user command set using the shortcut key. As an example only, if a user regularly watches a weather forecast program at a certain time every morning using a weather application installed in the apparatus 1, the user may create a user command set by defining a shortcut (e.g., Weather No. 1), a keyword (e.g., weather), a sentence (e.g., show me the weather), and the like with respect to a sequence of commands regarding a series of operations, such as “run a weather application,” “search for today's weather,” and “play the found program.” By doing so, the user can continuously navigate operations on the screen that are being carried out by the sequence of commands by inputting the predefined shortcut. Furthermore, if the user also watches a travel guide show, said user may also create a command set for tuning into the show by defining another shortcut key, for example, Weather No. 2.

In another example, each user may define his/her gesture regarding a particular command, and create a personalized user command set using the defined gesture.

The user command set is not limited to the aforesaid examples, and it may be defined in various ways according to the content displayed on the screen or the type of platform (e.g., web browser or applications).

The command composer 300 may translate an input command, which may be a primary command and/or an additional command. Then the command composer 300 may refer to the command set DB 350 to extract a command that corresponds to the input command, and may create a navigation command using the extracted command. Here, if the referenced command is defined in the personalized user command set DB 352, the user may be able to create the navigation command more promptly. Before the user has finished inputting his or her voice command, i.e., while the user's voice command is still being input, the command composer 300 may translate the speech that is currently being inputted, and create a plurality of navigation commands to be executed in stages. Thus, the command composer 300 translates or extracts the user's speech in real time and may even predict a number of possible user commands based on the real time translation of the user's speech. As an example, in the case where the user regularly watches a weather program at a certain time of day, when the user begins to input a voice command, such as “run”, “search”, or “play”, the command composer 300 may extract the input in real time and predict the voice command to be “run a weather application,” “search for today's weather,” or “play the found program”, respectively. The command composer 300 may also base the prediction on the time of day the voice command is input. By predicting the voice command of the user, the command composer 300 may reduce the time for executing the voice command as compared to not predicting the command.

Referring back to FIG. 1, the command executer 400 executes the command created by the command composer 300 of FIG. 1 to perform a corresponding navigation operation on the screen. For example, in response to the navigation command created by the command composer 300, the command executer 400 may highlight a specific keyword on the screen or navigate the screen to search for a new keyword. The command executer 400 may also carry out web browsing or a move to a previous or next page of the current page. In addition, the command executer 400 may zoom in on a particular area of the screen, open a link, or navigate files to play voice/image/video files. Further, the user may display the content of a particular email or message or search for emails and/or messages received on a specific date. In this case, if the command composer 300 has generated multiple navigation commands to be executed in stages according to the user's command, the command executer 400 may execute said commands in multiple stages and may sequentially display each execution result on the screen. In addition, as noted above and as only examples, the command composer 300 of FIG. 1 may be configured according to any or any combination of configurations of the command composers 300 of FIGS. 3A-3C, noting that embodiments are not limited thereto.

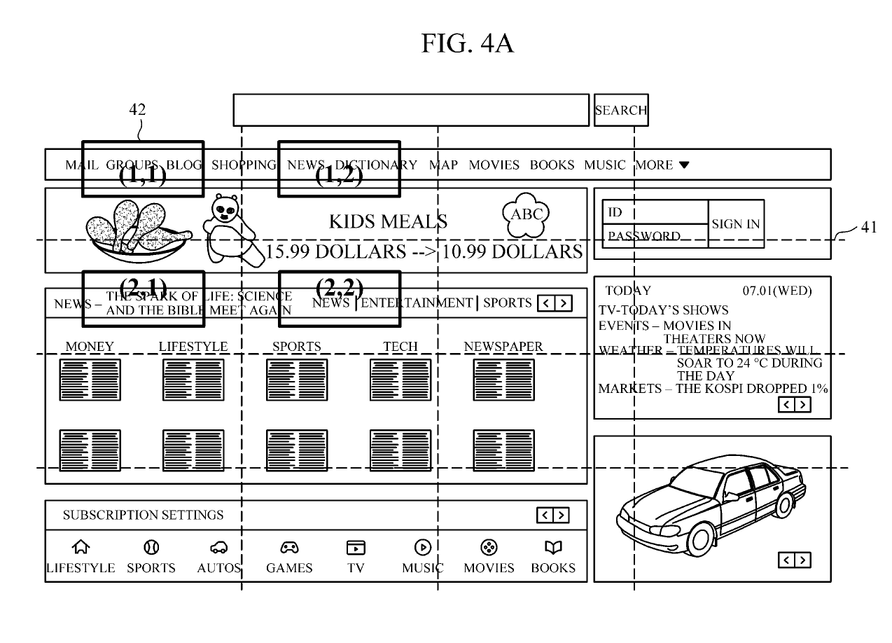

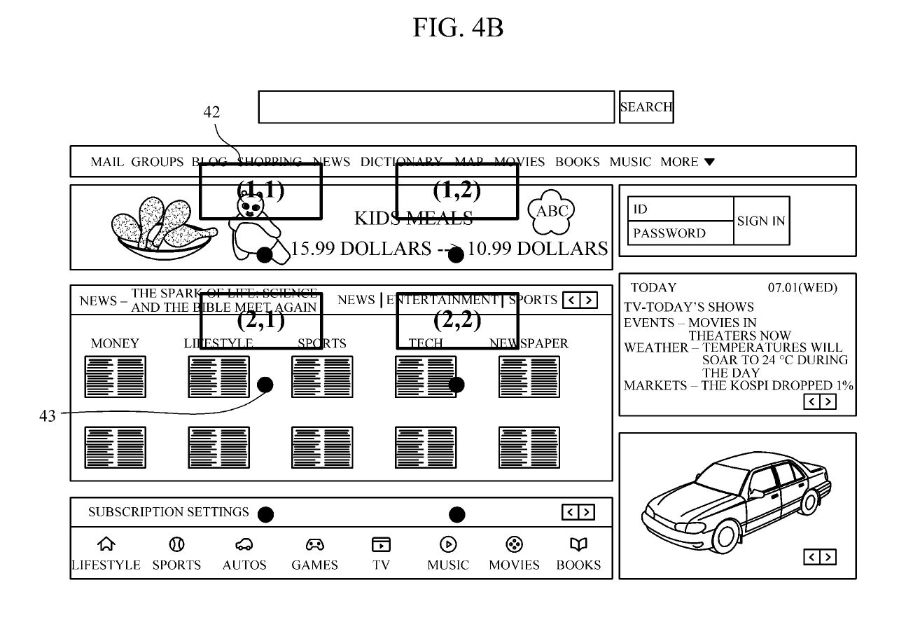

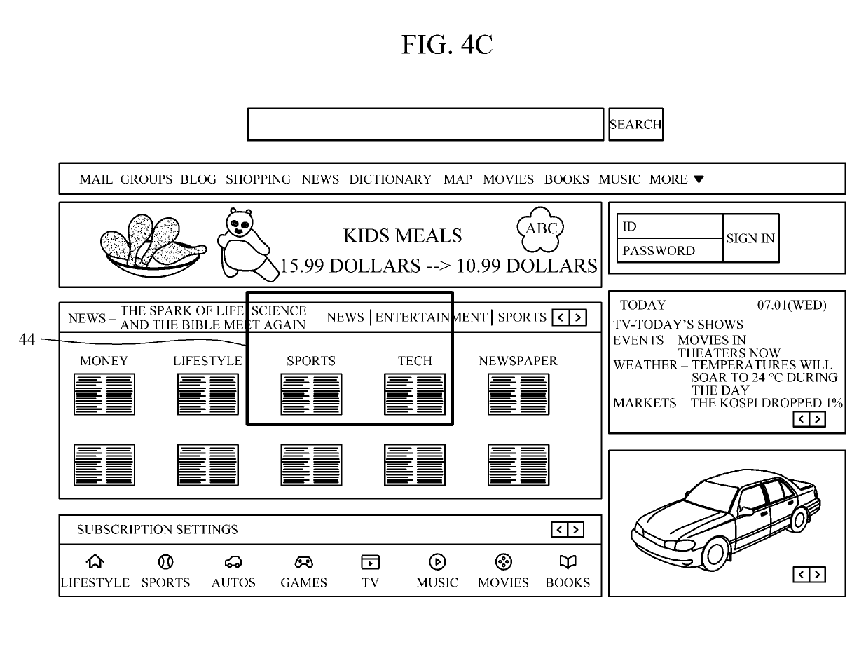

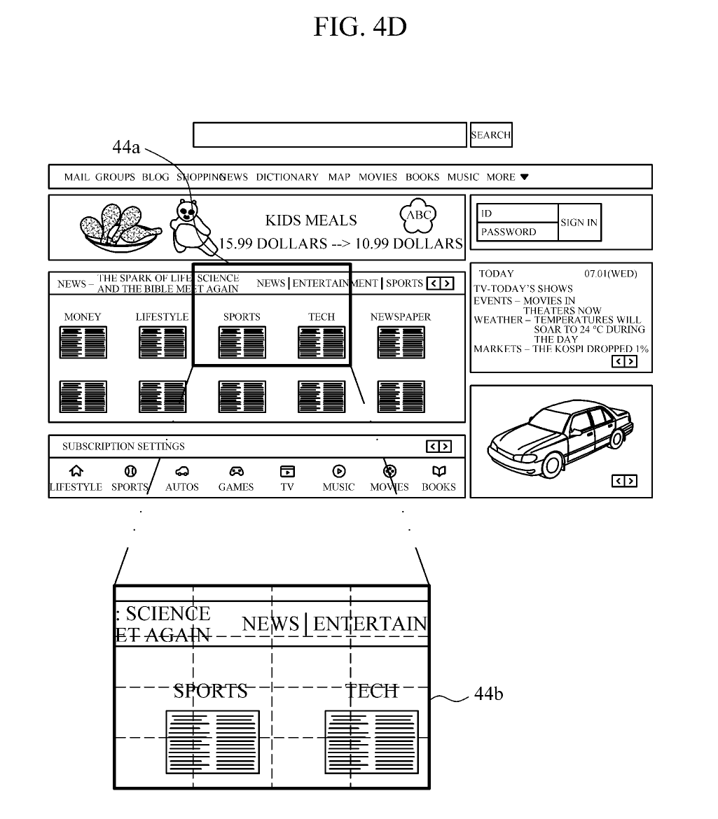

FIGS. 4A to 4D are diagrams illustrating screen indices displayed on the screen according to embodiments. The displayed screen indices may be representative of indices generated by the index display of FIG. 2, for example.

Referring to FIGS. 4A to 4D, a web page on portal site being illustrated as displayed on the screen. With respect to FIGS. 4A-4D, the index display 210 may display identification symbols such as a grid lines 41, grid coordinates 42, grid points 43, or area 44, e.g., rectangles 44, or any combination thereof, on the screen. As described above, the index display 210 may determine types and colors of indices. The index display 210 may also determine the types, thicknesses, and sizes of lines to be displayed on the screen by taking into account various factors, such as the screen size, the resolution of the screen, and analysis results of contents. The identification symbols provide an index for user voice commands. Therefore, a user can designate desired content on the screen by including the index in a voice command. For example, a user may input “enlarge coordinate one one” and the content within the area indexed to (1,1) may be enlarged. The user may also input “enlarge grid one one” or “enlarge point one one” and the content within the area indexed to the grid or grid point, respectively, may be enlarged. Additionally, and using area 44 as only an example, an interaction or operation (or implementation of the same) with respect to an area 44, or content represented by area 44, may be contextually determined, such as through the context of one of or any combination of two or more of a gaze, gesture, content, or command. For example, the command receiver 100 may receive a user's command and a gaze and/or gesture, and the command composer 300 may interpret the user's gaze or gesture, or consider the users gaze and/or gesture with respect to analyses of the corresponding content, to identify an area selected by the user to define the context for the command. As another example, the command receiver 100 may receive the user's command through a detected gesture, such as through a signaling or sign language, and use the user's gaze to provide context for the user's command. Alternatively, the command receiver 100 may receive the user's command through a detected gaze, e.g., where different gazes are predefined to correspond to particular commands, and use a detected gesture of the user, e.g., to identify one or more such grid identifiers, to provide context for the user's command.

According to an embodiment, the index display 210 may display indices in stages based on an additional command input by a user. For example, as shown in FIG. 4D, when the index display 210 displays a rectangular index 44a on the screen, the user may input a command, such as “Enlarge index”. In this case, when the command receiver 100 receives a user's command, the command composer 300 may interpret the user's command to identify an index selected by the user, and create a navigation command to enlarge an area indicated by the identified index. When the command executer 400 enlarges the pertinent area by executing the navigation command, the index display 210 may display a grid 44b as an additional index on the enlarged area in order to allow the user to further navigate said area.

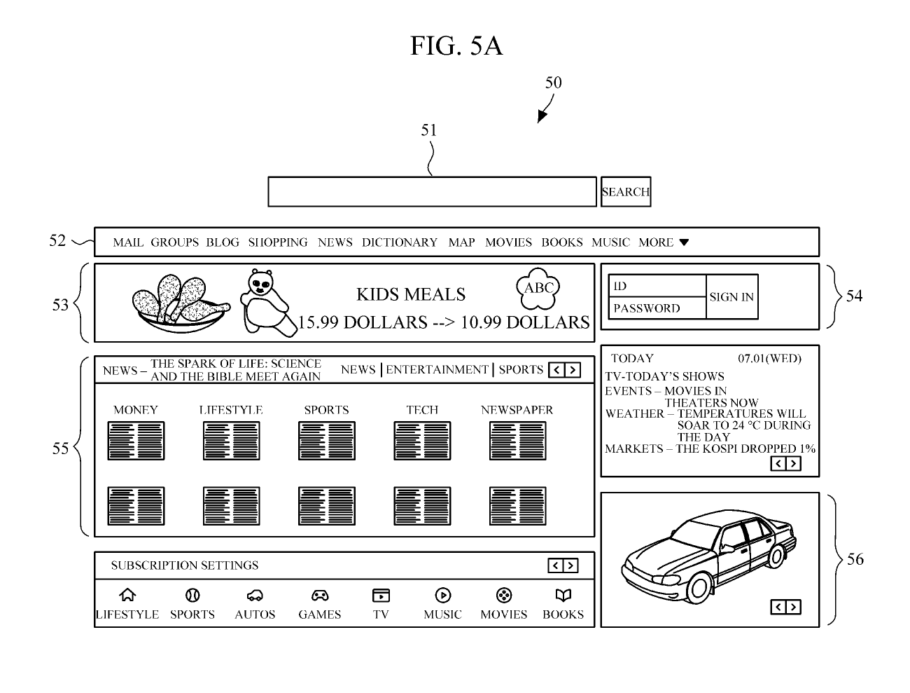

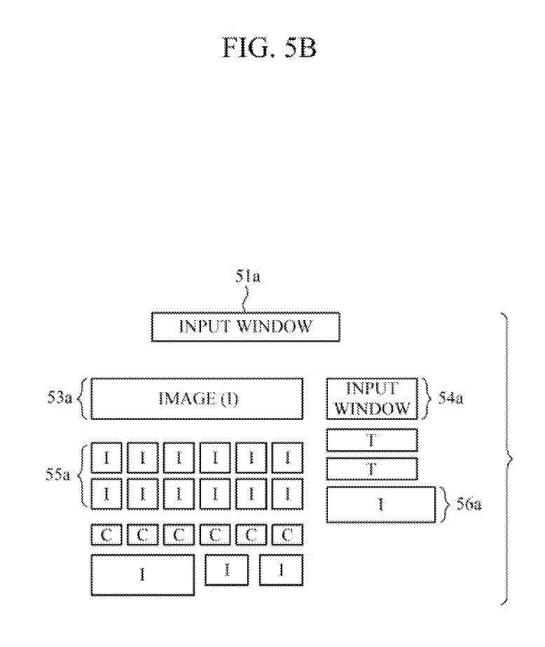

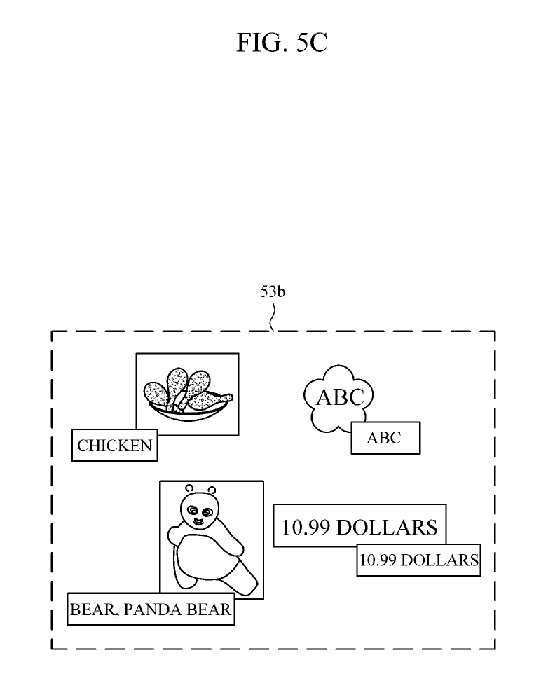

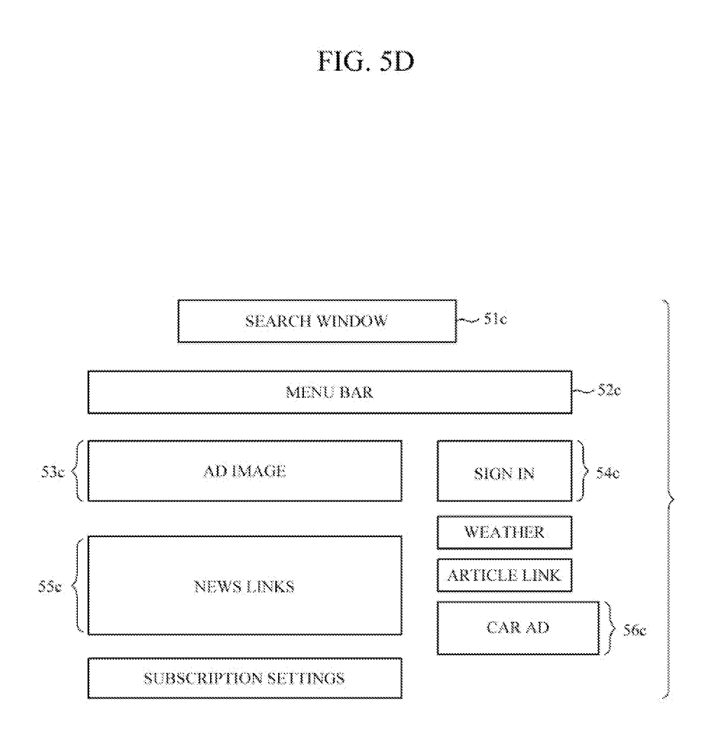

FIGS. 5A to 5D are diagrams illustrating procedures of creating a semantic map by a semantic map generator. The semantic map generator may be representative of the semantic map generator 220 of FIG. 2, though embodiments are not limited thereto.1.

Referring to FIG. 5A, a web page 50 of a portal site illustrated as being displayed on a screen, wherein the web page 50 consists of largely six areas 51, 52, 53, 54, 55, and 56. The semantic map generator 220 may analyze the screen and define each area 51, 52, 53, 54, 55, and 56 and each piece of content displayed on the screen.

According to an embodiment, the semantic map generator 220 may determine a type of each piece of content on the screen, such as text type, an icon type, a table type, and a link type, for example, by analyzing the source of the web page. Referring to FIG. 5B, the semantic map generator 220 may designate areas 51 and 54 as input windows 51a and 54a and designate areas 53 and 56 as images 53a and 56b, as an example only.

In an embodiment, the semantic map generator 220 may define the meaning of each piece of content using image analysis, text analysis, object extraction, classification and naming technologies. For example, referring to FIG. 5C, the semantic map generator 220 may extract individual objects from the image 53b in area 53 by using object extraction and text analysis, and define the meaning of each of the extracted objects as “chicken,” “brand ABC,” “bear/panda bear,” and “10.99 dollars”.

In an embodiment, the semantic map generator 220 may define each area 51, 52, 53, 54, 55, and 56 of FIG. 5A and each piece of content based on context information. Referring to FIG. 5D, the semantic map generator 220 may define area 51 and area 54, which are input windows, as a search window 51c and a sign-in window 54c, respectively. Also, the semantic map generator 220 may define area 52 as a menu bar 52c. The semantic map generator 220 may define area 53 and area 56 as an advertisement image 53c and a car advertisement 56c, respectively. Further, the semantic map generator 220 may define area 55 as news links 55c.

The semantic map generator 220 may define the meaning of each piece of content displayed on the screen by synthesizing analysis results obtained by various schemes, as shown in FIGS. 5B to 5D, and may create a semantic map and the disclosure is not limited to the schemes shown therein.

Once the semantic map has been created, the user may easily select specific content displayed on the screen using a natural language command. For example, the user may select a sports newspaper in area 55 by inputting an additional command, “newspaper, the third one on the top”. Thereafter, the user may carry out various operations by further inputting primary commands. For example, the user may display or zoom in on the content of the sports newspaper or display the previous/next page of the newspaper.

In addition, the user may input a combination of a primary command and an additional command. For example, the user may input command “Zoom in ABC ad” to zoom in on the image of the fried chicken of ABC brand in area 53, or may input command “play the vehicle ad” to play a slide show of the vehicle advertisement in area 56.

In response to the input of the user's command, the command composer 300 may utilize the semantic map to identify the content chosen by the user, and then compose a command for said content.

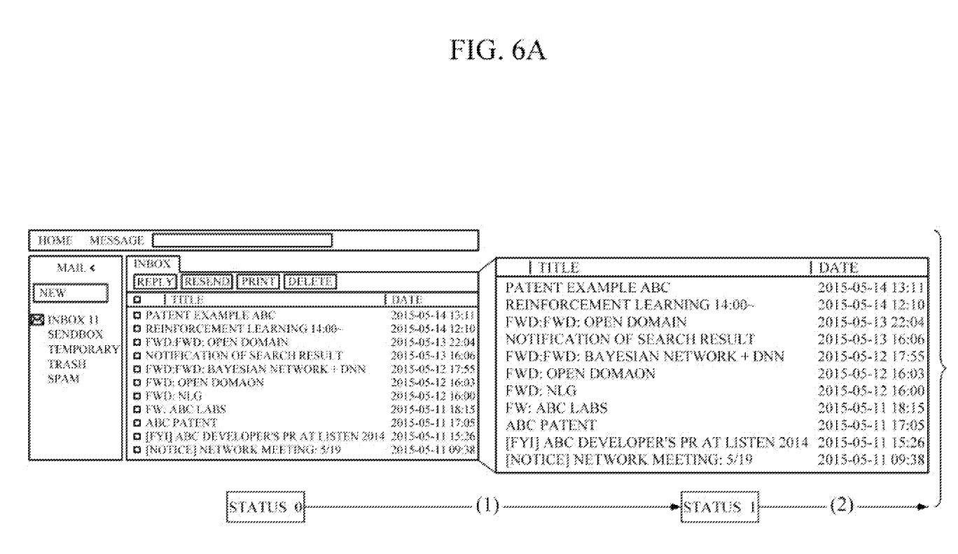

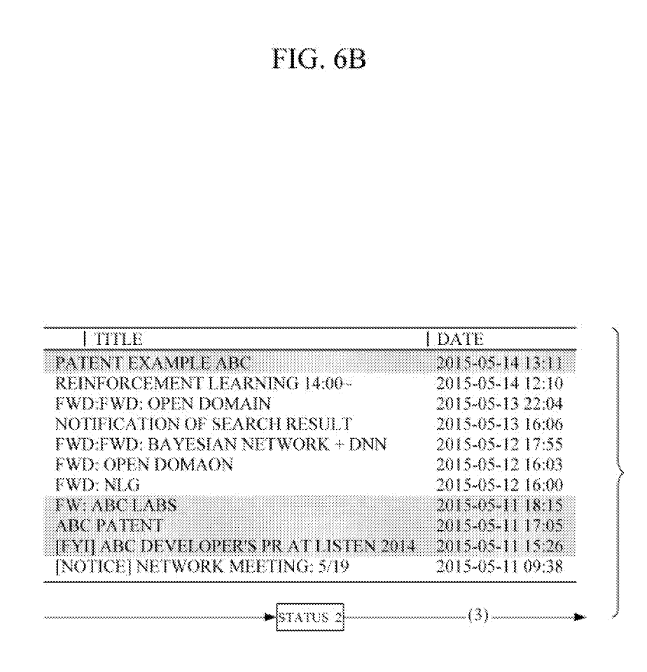

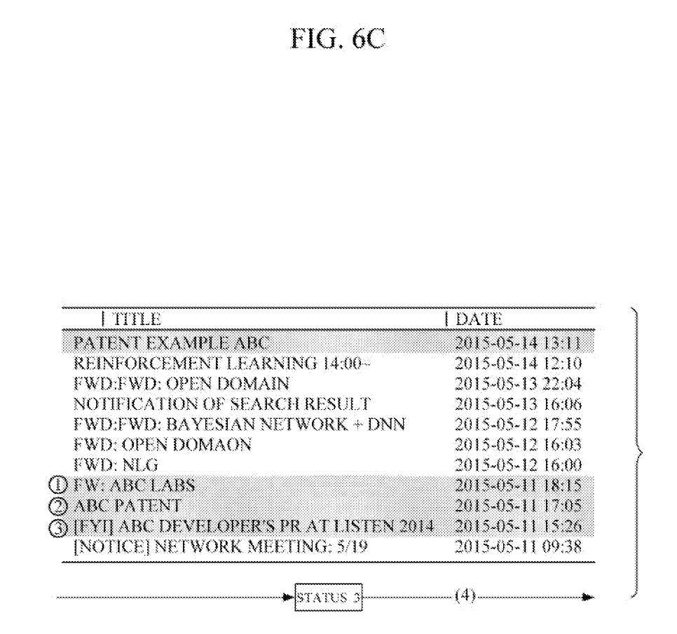

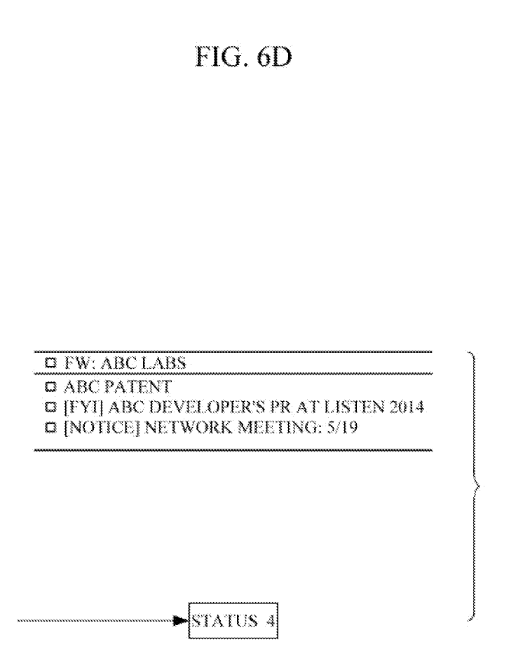

FIGS. 6A to 6D are diagrams illustrating an example of screen navigation, according to an embodiment. The example screen navigation may be performed by the command executer of FIG. 1, for example.

FIGS. 6A to 6D show one example of various navigation processes performed by a command executer 400, in which the content of an email is displayed in stages according to a user's command. The command executer 400 may be representative of the commend executor of FIG. 1, though embodiments are not limited thereto.

Assuming that the date is May 14, 2015, when the user inputs a natural language command, “Open the latest email received before today regarding ABC in the email list,” a command composer 300, such as any of the command composers of FIGS. 1 and 3A-3C, may interpret that the command is formed of four stages: (1) the email list; (2) (emails) regarding ABC; (3) received before today; and (4) open the latest one. The composer 300 may then compose navigation commands associated with the respective stages.

The command executer 400 may sequentially execute the four-staged navigation commands, and display the execution results in stages, as shown in FIGS. 6A to 6D. Referring to FIG. 6A, the command executer 400 displays an inbox (status 0), and an email list (status 1). Then, the command executer 400 then highlights the emails regarding “ABC” in the email list (status 2), as shown in FIG. 6B, and thereafter numbers each email (\textcircled{1}, \textcircled{2}, \textcircled{3}) that is received before today, among the emails regarding “ABC” (status 3), as shown in FIG. 6C. Finally, the command executer 400 displays the content of the latest email among the numbered emails (status 4), as shown in FIG. 6D.

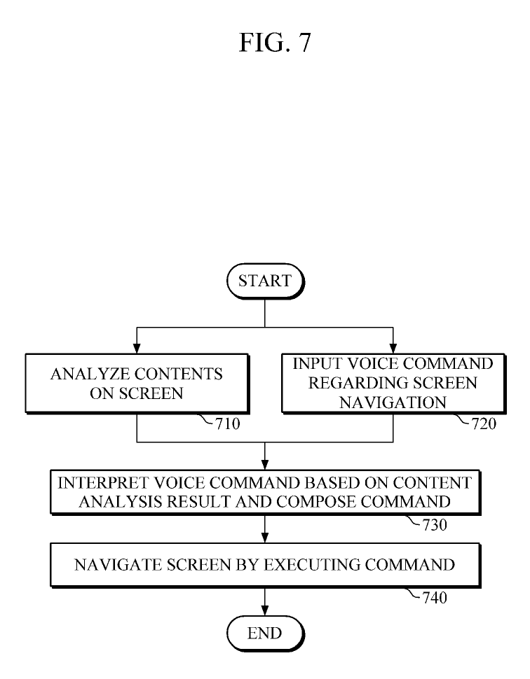

FIG. 7 is a flowchart illustrating a screen navigation method according to an embodiment.

FIG. 7 illustrates an embodiment of the screen navigation method performed by a screen navigation apparatus. Though the below description will be made with reference to the screen navigation apparatus 1 of FIG. 1, this is done for convenience of explanation and embodiments are not limited thereto. Various embodiments that may be performed by the screen navigation apparatus 1 are described above.

Referring to FIG. 7, the screen navigation apparatus 1 analyzes content displayed on the screen and generates the analysis result in operation 710. At this time, the content analysis result may include, but is not limited to, one of a screen index and a semantic map.

According to the embodiment, the screen navigation apparatus 1 may display a screen index of a predesignated type or size, and, if needed, may determine standards for the size, color, display position, display viewpoint of the index in consideration of the size and resolution of the screen, and the distribution positions of key contents. In this case, the screen index may include a grid, coordinates, and identification symbols of various forms. Once the screen index has been determined, the screen navigation apparatus 1 may display the determined screen index on the screen. The index may be displayed immediately after the content is output to, or displayed on, the screen, or after an index display command is input from the user.

In an embodiment, the screen navigation apparatus 1 may analyze each content on the screen to define the meaning of the content, and generate a semantic map that contains definition of each content. At this time, the screen navigation apparatus 1 may define meanings of particular content by analyzing a source of a webpage on which the content is displayed or by analyzing said content through object extraction through image analysis or key-word extraction through text analysis.

In an embodiment, the meaning of each content may be determined based on the contextual information. The results may be derived through the analyses, as described above, and may be combined to generate the semantic map. Also, the screen navigation apparatus 1 receives a primary command input from the user, as depicted in operation 720. The user may input an additional command as well as the primary command. To input the additional command, various methods, such as user's voice, eye-gaze, or gestures may be used, as described above.

Operations of analyzing the content on the screen, as depicted in operation 710 and receiving the input command, as depicted in operation 720, are not limited to any particular order. That is, the user may input an intended command based on the content analysis result, or the content on the screen may be analyzed in response to the input user command. Alternatively, the content on the screen may be analyzed while the user is inputting the user command, or vice versa.

The screen navigation apparatus 1 may interpret a voice command based on the content analysis result and compose a navigation command, as depicted in operation 730. The screen navigation apparatus 1 may preprocess the natural-language voice command into the format that is desired, and compose the navigation command based on the preprocessing result.

According to an embodiment, the screen navigation apparatus 1 may refer to a predefined command set DB to extract a command that corresponds to the user command, and may compose the commands so that their formats are ones which allow for execution. At this time, the command set DB may include the common command set DB and/or the user command set DB, as described above.

The screen navigation apparatus 1 executes the composed command to perform various navigation operations, such as highlighting a keyword, zoom-in, search, and moving to a previous/next page, as an example only, as depicted in operation 740.

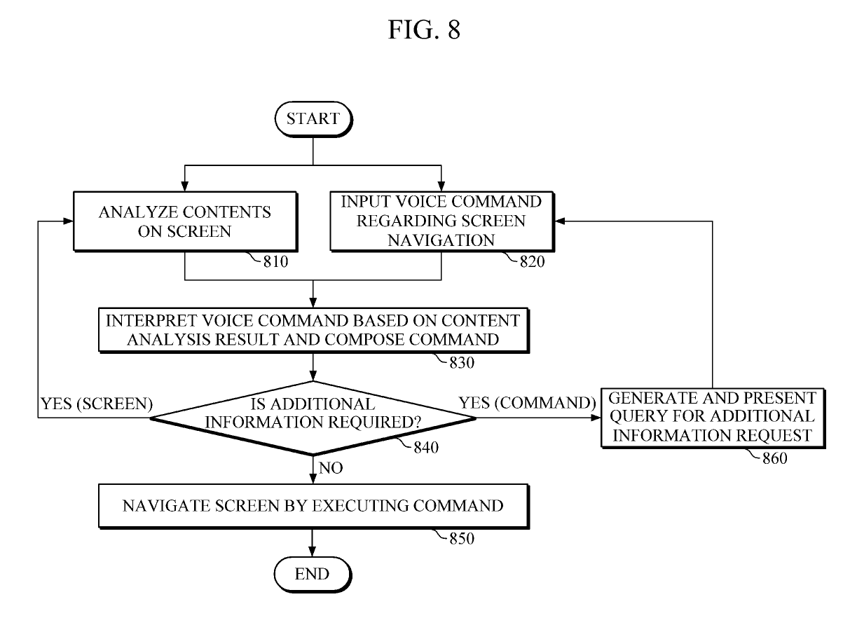

FIG. 8 is a flowchart illustrating a screen navigation method according to an embodiment. FIG. 8 shows an embodiment of the screen navigation method. The method may be performed by a screen navigation apparatus. Though the below description will be made with reference to the screen navigation apparatus 1 of FIG. 1, this is done for convenience of explanation and embodiments are not limited thereto. Various embodiments performed by the screen navigation apparatus 1 are described above.

Referring to FIG. 8, the screen navigation apparatus 1 analyzes content displayed on the screen and generates an analysis result, as depicted in operation 810. For example, the screen navigation apparatus 1 may generate an index to be displayed on the screen by analyzing the content on the screen, and display the generated index on the screen. The screen navigation apparatus 1 may also generate a semantic map by defining the meaning of each content displayed on the screen.

The screen navigation apparatus 1 may receive a user's voice command, i.e., a primary command regarding the screen navigation, as depicted in operation 810. Here, the screen navigation apparatus 1 may receive an additional command as well as the primary command. The input of the command is not limited to any particular method, and various methods as described above may be used.

Operations of analyzing the content on the screen, as depicted in operation 810, and receiving the user command, as depicted in operation 820, are not limited to any particular order. That is, the user may input an intended command based on the content analysis result, or the content on the screen may be analyzed in response to the input user command. Alternatively, the content on the screen may be analyzed while the user is inputting the command, or vice versa.

Thereafter, the screen navigation apparatus 1 composes a navigation command by interpreting the voice command based on the content analysis result, as depicted in operation 830.

Here, the screen navigation apparatus 1 may perform various predesignated preprocessing operations that are desired to compose the navigation command. The screen navigation apparatus 1 may convert the user command into a navigation command based on the preprocessing result. The screen navigation apparatus 1 may extract any executable commands that correspond to the user command from the command set DB, and may compose the navigation command using the extracted commands. The command set DB may include at least one of the common command set DB and the user command set DB.

Then, the screen navigation apparatus 1 determines whether additional information is desired for composing the navigation command, as depicted in operation 840. The screen navigation apparatus 1 may determine whether additional information regarding the command input from the user is desired or not. Also, the screen navigation apparatus 1 may determine whether additional information regarding the analysis of content on the screen is desired or not. For example, additional analysis may be desired for a particular area on the screen that the user wants to zoom in on or particular content the user wants to choose.

If it is determined in operation 840 that the additional information about the user command is desired, the screen navigation apparatus 1 creates a query to request the additional information and presents the query to the user, as depicted in operation 860. Here, the screen navigation apparatus 1 may generate the query formed of multistage sub-queries, and present each subquery to the user in stages based on the user's reply.

As such, if the user inputs additional information in stages in response to the multistage subqueries presented, the screen navigation apparatus 1 may compose a navigation command for each stage, so that the navigation of the screen can be performed in a stepwise manner.

If it is determined in operation 840 that the additional information regarding analysis of content on the screen is desired, the flow chart illustrates returning to operation 810 where the screen navigation apparatus 1 performs additional analysis on an area or content if any is desired.

However, if it is determined in operation 840 that the additional information is not desired, the screen navigation apparatus 1 executes the composed navigation command to navigate the screen, as depicted in operation 850.

The command receiver 100, respective screen analyzers 200, respective command composers 300, command executer 400, index display 210, semantic map generator 220, respective preprocessor 310, respective command converters 320, additional information determiner 330, dialog agent 340, command set database (DB) 350, common command set DB 351, user command set DB 352, transceiver 110, display 120, a user interface 130, and memory 140, in FIG. 1-30 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 4A-8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

As a non-exhaustive example only, an apparatus as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A screen navigation apparatus comprising:
a command receiver configured to receive an input voice command regarding navigation of a screen;
a processor configured to:
interpret the voice command based on an analysis result of content displayed on a screen and compose a command executable by the screen navigation apparatus; and
perform navigation of the screen.

2. The screen navigation apparatus of claim 1, further comprising a memory configured to store instructions;
wherein the processor is further configured to execute the instructions to configure the processor to:
interpret the voice command based on the analysis result of the content displayed on the screen and compose the command executable by the screen navigation apparatus; and
perform the navigation of the screen.

3. The screen navigation apparatus of claim 1, wherein the processor comprises:
a command composer configured to interpret the voice command based on the analysis result of the content displayed on the screen and compose the command executable by the screen navigation apparatus; and
a command executer configured to perform the navigation of the screen.

4. The screen navigation apparatus of claim 3, wherein the processor further comprises:
a screen analyzer configured to analyze the content displayed on the screen and generate the content analysis result.

5. The screen navigation apparatus of claim 4, wherein the screen analyzer is configured to analyze the content using one or more of the following techniques: source analysis, text analysis, speech recognition, image analysis and context information analysis.

6. The screen navigation apparatus of claim 4, wherein the content analysis result comprises a semantic map or a screen index, or both,
wherein the semantic map represents a determined meaning of the content displayed on the screen, and the screen index indicates a determined position of the content displayed on the screen.

7. The screen navigation apparatus of claim 6, wherein the screen index comprises at least one of the following items: coordinates, grids, and identification symbols, and
the screen analyzer determines at least one of a type, size, and position of the screen index to be displayed on the screen by taking into account at least one of the following factors:
coordinates of the screen index, a screen resolution, and positions and distribution of key contents on the screen, and displays the screen index on the screen based on the determination.

8. The screen navigation apparatus of claim 7, wherein in response to a user selecting one of screen indices displayed on the screen by a user's speech, eye-gaze, or gesture, or any combination thereof, the command composer is configured to interpret the voice command based on screen position information that corresponds to the selected screen index.

9. The screen navigation apparatus of claim 3, wherein the command receiver is configured to receive the input voice command from a user in a predetermined form or in a form of natural language.

10. The screen navigation apparatus of claim 9, wherein the processor further comprises the command receiver.

11. The screen navigation apparatus of claim 9, wherein the command composer comprises a command converter configured to refer to a command set database (DB) and convert the input voice command into a command executable by the screen navigation apparatus.

12. The screen navigation apparatus of claim 11, wherein the command set DB comprises a common command set DB or a user command set DB, or both,
wherein the common command set DB stores common command sets and the user command set DB that stores command sets personalized for a user.

13. The screen navigation apparatus of claim 3, wherein the command composer comprises an additional information determiner configured to determine whether the input voice command is sufficient to be composed into the command, and a dialog agent configured to present a query to request the user to provide additional information in response to the determination indicating that the voice command is not sufficient.

14. The screen navigation apparatus of claim 13, wherein the dialog agent is configured to create the query as multistage subqueries, and present a subquery based on a user's reply to a subquery presented in a previous stage.

15. The screen navigation apparatus of claim 3, wherein the command composer is configured to interpret the incoming voice command in stages and compose a command for each stage while the user's voice command is being input, and
the command executer is configured to navigate the screen in stages by executing the commands.

16. The screen navigation apparatus of claim 3, wherein the navigation of the screen comprises one or more of the following operations: keyword highlighting, zoom-in, opening a link, running an image, playing video, and playing audio.

17. The screen navigation apparatus of claim 1, wherein the screen navigation apparatus is a smartphone, a laptop, a tablet, a smart watch, or a computer, and further comprises a screen and a user interface.

18. A screen navigation method comprising:
receiving a voice command regarding navigation of a screen;
interpreting the voice command based on an analysis result of content displayed on the screen and composing a command; and
performing navigation of the screen based on execution of the command.

19. The screen navigation method of claim 18, further comprising:
analyzing content displayed on the screen and generating a content analysis result.

20. The screen navigation method of claim 19, wherein the content analysis result comprises a semantic map or a screen index, or both,
wherein the semantic map represents a determined meaning of the content displayed on the screen and the screen index indicates a determined position of the content displayed on the screen.

21. The screen navigation method of claim 19, wherein the composing of the command comprises:
in response to the screen index displayed on the screen being selected by a user's speech, eye-gaze or gesture, or any combination thereof, interpreting the received voice command based on screen position information that corresponds to the selected screen index.

22. The screen navigation method of claim 18, wherein the receiving of the voice command comprises receiving the input voice command from a user in a predetermined form or in a form of natural language.

23. The screen navigation method of claim 22, wherein the composing of the command comprises comparing the input voice command to a command set database (DB) and converting the input voice command into the command.

24. The screen navigation method of claim 18, wherein the composing of the command comprises determining whether the input voice command is sufficient to be composed into a command, and in response to a result of the determining being that the voice command is not sufficient, presenting a query to request the user to provide additional information.

25. The screen navigation method of claim 24, wherein the presenting of the query comprises creating the query as multistage subqueries, and presenting a subquery based on a user's reply to a subquery presented in a previous stage.

26. The screen navigation method of claim 18, wherein the composing of the command comprises:
interpreting the incoming voice command in stages while a user's voice command is being input and composing a command for each stage, and the performing of the navigation comprises navigating the screen in stages by executing the commands.
